(19) United States
(12) Patent Application Publication
(10) Pub. No.: US 2024/0127996 A1
(43) Pub. Date: Apr. 18, 2024

(54) R-T-B MAGNET AND PREPARATION METHOD THEREFOR

(71) Applicant: FUJIAN CHANGTING GOLDEN DRAGON RARE-EARTH CO., LTD, Longyan, Fujian (CN)

(72) Inventors: Weiguo MOU, Longyan (CN); Jiaying HUANG, Xiamen (CN)

(73) Assignee: FUJIAN CHANGTING GOLDEN DRAGON RARE-EARTH CO., LTD, Longyan, Fujian (CN)

(21) Appl. No.: 18/277,523

(22) PCT Filed: Jan. 17, 2022
(86) PCT No.: PCT/CN2022/072248

§ 371 Date: Aug. 16, 2023

(30) Foreign Application Priority Data
Mar. 17, 2021 (CN) 202110286616.X

(51) Int. Cl. H01F 1/057; H01F 41/02

(52) U.S. Cl. CPC H01F 1/0577; H01F 41/0293

(57) ABSTRACT

A R-T-B magnet and a preparation method thereof. The R-T-B magnet includes the following components of: ≥30.0 wt % of R, said R is a rare earth element; 0.16-0.6 wt % of Cu; 0.4-0.8 wt % of Ti; ≤0.2 wt % of Ga; 0.955-1.2 wt % of B; and 58-69% of Fe; wherein wt % is the mass percentage of respective component in the total mass of all components. The R-T-B magnet has higher remanence, coercivity, squareness and high-temperature stability.

### FIELD OF THE INVENTION

The invention relates to a R-T-B magnet and a preparation method thereof.

### BACKGROUND OF THE INVENTION

As an important class of rare earth functional materials, the neodymium-iron-boron permanent magnet materials have excellent comprehensive magnetic properties and are widely used in many fields such as the electronics industry and electric vehicles. However, the current neodymium-iron-boron magnet materials have poor temperature stability, which limits their application in high temperature fields.

For example, Chinese patent document CN102412044A discloses a neodymium-iron-boron magnet material, which comprises the following components by mass: 23-30% of Nd, 0.5-8% of Dy, 0.2-0.5% of Ti, 2.5-4% of Co, 0.2-3.8% of Nb, 0.05-0.7% of Cu, 0.01-0.9% of Ga, and 0.6-1.8% B. This patent document only records that the corrosion resistance of the material is greatly improved by compound addition of Ti, Ga and Co, and at the same time, the use of Ga to replace Dy plays a partial role in the material which reduces the cost. However, the patent does not further study how it will affect the performance of the magnet material. The example in this patent discloses the following components by mass: 28.3% of Nb, 3.2% of Dy, 0.3% of Ti, 2.7% of Co, 0.7% of Nb, 0.4% of Cu, 0.25% of Ga and 1.2% of B. The formula of the magnet material cannot make full use of the improvement effect of respective elements on the magnetic properties of the neodymium-iron-boron magnet material, and it is impossible to obtain a magnet material with good coercivity, remanence and high-temperature stability.

At present, it is necessary to further optimize the formula of neodymium-iron-boron magnet materials in the prior art to obtain magnet materials with better comprehensive magnetic properties.

### SUMMARY OF THE INVENTION

In order to remove the defect that the magnets obtained according to the formula of the neodymium-iron-boron magnet materials existing in the prior art cannot achieve high level of remanence, coercivity, high-temperature stability and squareness at the same time, the invention provides a R-T-B magnet and a preparation method thereof. Through the combination of specific element types and specific contents in the neodymium-iron-boron magnet magnets of the present invention, magnet materials with higher remanence, coercivity and squareness, and better high-temperature stability can be prepared.

The present invention solves the above-mentioned technical problem mainly through the following technical solutions.

The invention further provides a R-T-B magnet, comprising the following components of:
≥30.0 wt % of R, said R is a rare earth element;
0.16-0.6 wt % of Cu;
0.38-0.8 wt % of Ti;
≤0.2 wt % of Ga;
0.955-1.2 wt % of B; and
58-69% of Fe; wherein
wt % is the mass percentage of respective component in the total mass of all components.

In the invention, the content of R is preferably 30.5 wt % or more, more preferably 30.5-32 wt %, such as 30.6 wt % or 32 wt %.

In the invention, the R generally can further comprise Nd.

Wherein the content of Nd is preferably 29-31 wt %, such as 28.6 wt %, 29.6 wt %, 29.8 wt %, 30 wt %, 30.2 wt %, 30.4 wt %, 30.6 wt % or 31 wt %, wherein wt % is the mass percentage of Nd in the total mass of all components.

In the invention, the R generally further comprises Pr and/or RH, and the RH is a heavy rare earth element.

Wherein, the content of the Pr is preferably 0.3 wt % or less.

Wherein the content of the RH is preferably 2 wt % or less, such as 0.2 wt %, 0.4 wt %, 0.6 wt %, 0.8 wt %, 1 wt % or 2 wt %, wherein wt % is the mass percentage of RH in the total mass of all components.

Wherein the RH preferably comprises Tb and/or Dy.

When the R comprises Tb, the content of Tb is preferably 1.4 wt % or less, such as 0.2 wt %, 0.4 wt %, 0.5 wt %, 0.6 wt %, 0.8 wt % or 1 wt %, wherein wt % is the mass percentage of Tb in the total mass of all components.

When the R comprises Dy, the content of Dy is preferably 0.5-2 wt %, wherein wt % is the mass percentage of Dy in the total mass of all components.

Wherein, the ratio of the atomic percentage of RH to the atomic percentage of R can be 0.1 or less, such as 0.02, 0.04, 0.05, 0.06, 0.07, 0.08 or 0.09, wherein the atomic percentage refers to the atomic percentage in the total content of all components.

In the invention, the content of Cu is preferably 0.16-0.45 wt %, such as 0.16 wt %, 0.21 wt %, 0.34 wt % or 0.45 wt %, preferably 0.16-0.35 wt %.

In the invention, the content of Ti is preferably 0.4-0.7 wt %, such as 0.4 wt %, 0.45 wt %, 0.55 wt %, 0.6 wt % or 0.7 wt %, preferably 0.4-0.5 wt %.

In the invention, the content of Ga is preferably 0.01-0.19 wt %, such as 0.01 wt %, 0.02 wt %, 0.06 wt % or 0.19 wt %, preferably 0.01-0.06 wt %.

In the invention, the content of B is preferably 0.96-1.15 wt %, such as 0.96 wt %, 1 wt %, 1.04 wt % or 1.15 wt %.

In the invention, the ratio of the atomic percentage of B to the atomic percentage of R in the R-T-B magnet can be 0.35 or more, such as 0.401, 0.420, 0.436, 0.437, 0.438, 0.455 or 0.503, preferably 0.42-0.51, wherein the atomic percentage refers to the atomic percentage in the total content of all components.

In the invention, the content of Fe is preferably 66-68 wt %, such as 66.3 wt %, 66.66 wt %, 66.68 wt %, 67.09 wt %, 67.43 wt %, 67.5 wt %, 67.54 wt %, 67.57 wt %, 67.58 wt %, 67.64 wt %, 67.67 wt %, 67.68 wt %, 67.7 wt %, 67.75 wt %, or 67.8 wt %.

In the invention, the R-T-B magnet generally can further comprise Al.

Wherein the content of Al is preferably 0.18 wt % or less, such as 0.02 wt %, 0.04 wt %, 0.05 wt %, 0.06 wt %, 0.07 wt % or 0.14 wt %, more preferably 0.02-0.08 wt %, wherein wt % is the mass percentage of Al in the total mass of all components.

In the invention, the R-T-B magnet generally can further comprise Co.

Wherein the content of Co is preferably 0.5-1.5 wt %, such as 1 wt %, wherein wt % is the mass percentage of Co in the total mass of all components.

In the present invention, those skilled in the art know that inevitable impurities, such as C and/or O, will be introduced into the R-T-B magnet during the preparation process.

In the process of optimizing the formula of the R-T-B magnet, the inventors found that, the magnetic properties such as the coercivity, the high-temperature stability and the squareness and the like of the obtained R-T-B magnet were significantly improved through the coordination of the above-mentioned specific contents of Cu, Ti, Ga and other elements.

The inventor further analyzed and found that after the R-T-B magnet was prepared according to the above specific formula of the present application, a TiₓCu_{y}B_{1-x-y} phase with a specific area ratio was formed in the R-T-B magnet. The existence of this phase can significantly hinder the grain growth, so that the size of the main phase grain in the magnet is more uniform, thereby obtaining the R-T-B magnet of the present invention with excellent comprehensive magnetic properties.

In the invention, the R-T-B magnet preferably comprises a TiₓCu_{y}B_{1-x-y} phase, wherein x is 20-30, y is 20-30, and 1−x−y is 40-60, wherein x, y, and 1-x-y refer to the atomic percentages of Ti, Cu, and B respectively in the TiₓCu_{y}B_{1-x-y} phase. The TiₓCu_{y}B_{1-x-y} phase is located in an intergranular triangular region, and the ratio of the area of the TiₓCu_{y}B_{1-x-y} phase to the total area of “a neodymium-rich phase and the intergranular triangular region” is 1-5%. In the present invention, the intergranular triangular region generally refers to the grain boundary phase formed among more than three main phase particles. In the present invention, the area of the TiₓCu_{y}B_{1-x-y} phase and the total area of “a neodymium-rich phase and the intergranular triangular region” generally refer to the areas respectively occupied in the cross section of the R-T-B detected by FE-EPMA.

Wherein:
the value of x is, for example, 21, 22, 23, 24, 25 or 27;
the value of y is, for example, 21, 22, 23, 24, 25, 26 or 27;
the value of 1-x-y is, for example, 48, 49, 50, 51, 52, 53, 55 or 58.

Wherein, the ratio of the area of the TiₓCu_{y}B_{1-x-y} phase to the total area of “the neodymium-rich phase and the intergranular triangular region” is preferably 2.54%, such as 2.9%, 3.2%, 3.4%, 3.5%, 3.6% %, 3.7% or 3.9%.

In a specific example of the invention, the R-T-B magnet comprises the following components of: 29.6 wt % of Nd, 1 wt % of Tb, 0.21 wt % of Cu, 0.45 wt % of Ti, 1 wt % of B, 0.02 wt % of Ga, 0.04 wt % of Al, and 67.68 wt % of Fe, wherein wt % is the mass percentage of respective component in the total mass of all components; the R-T-B magnet comprises a Ti₂₃Cu₂₅B₅₂ phase in an intergranular triangular region thereof, and the ratio of the area of the Ti₂₃Cu₂₅B₅₂ phase to the total area of “the neodymium-rich phase and the intergranular triangular region” is 3.5%.

In a specific example of the invention, the R-T-B magnet comprises the following components of: 29.8 wt % of Nd, 0.8 wt % of Tb, 0.21 wt % of Cu, 0.45 wt % of Ti, 1 wt % of B, 0.02 wt % of Ga, 0.05 wt % of Al, and 67.67 wt % of Fe, wherein wt % is the mass percentage of respective component in the total mass of all components; the R-T-B magnet comprises a Ti₂₃Cu₂₄B₅₃ phase in an intergranular triangular region thereof, and the ratio of the area of the Ti₂₃Cu₂₄B₅₃ phase to the total area of “the neodymium-rich phase and the intergranular triangular region” is 3.4%.

In a specific example of the invention, the R-T-B magnet comprises the following components of: 30 wt % of Nd, 0.6 wt % of Tb, 0.21 wt % of Cu, 0.45 wt % of Ti, 1 wt % of B, 0.02 wt % of Ga, 0.04 wt % of Al, and 67.68 wt % of Fe, wherein wt % is the mass percentage of respective component in the total mass of all components; the R-T-B magnet comprises a Ti₂₂Cu₂₆B₅₂ phase in an intergranular triangular region thereof, and the ratio of the area of the Ti₂₂Cu₂₆B₅₂ phase to the total area of “the neodymium-rich phase and the intergranular triangular region” is 3.6%.

In a specific example of the invention, the R-T-B magnet comprises the following components of: 30.2 wt % of Nd, 0.4 wt % of Tb, 0.21 wt % of Cu, 0.45 wt % of Ti, 1 wt % of B, 0.02 wt % of Ga, 0.08 wt % of Al and 67.64 wt % of Fe, wherein wt % is the mass percentage of respective component in the total mass of all components; the R-T-B magnet comprises a Ti₂₅Cu₂₅B₅₀ phase in an intergranular triangular region thereof, and the ratio of the area of the Ti₂₅Cu₂₅B₅₀ phase to the total area of “the neodymium-rich phase and the intergranular triangular region” is 3.5%.

In a specific example of the invention, the R-T-B magnet comprises the following components of: 30.4 wt % of Nd, 0.2 wt % of Tb, 0.21 wt % of Cu, 0.45 wt % of Ti, 1 wt % of B, 0.02 wt % of Ga, 0.02 wt % of Al and 67.7 wt % of Fe, wherein wt % is the mass percentage of respective component in the total mass of all components; the R-T-B magnet comprises a Ti₂₄Cu₂₆B₅₀ phase in an intergranular triangular region thereof, and the ratio of the area of the Ti₂₄Cu₂₆B₅₀ phase to the total area of “the neodymium-rich phase and the intergranular triangular region” is 3.5%.

In a specific example of the invention, the R-T-B magnet comprises the following components of: 30.6 wt % of Nd, 0.21 wt % of Cu, 0.45 wt % of Ti, 1 wt % of B, 0.02 wt % of Ga, 0.05 wt % of Al and 67.67 wt % of Fe, wherein wt % is the mass percentage of respective component in the total mass of all components; the R-T-B magnet comprises a Ti₂₂Cu₂₃B₅₅ phase in an intergranular triangular region thereof, and the ratio of the area of the Ti₂₂Cu₂₃B₅₅ phase to the total area of “the neodymium-rich phase and the intergranular triangular region” is 3.2%.

In a specific example of the invention, the R-T-B magnet comprises the following components of: 29.6 wt % of Nd, 1 wt % of Tb, 1 wt % of Co, 0.21 wt % of Cu, 0.45 wt % of Ti, 1 wt % of B, 0.02 wt % of Ga, 0.04 wt % of Al and 66.68 wt % of Fe, wherein wt % is the mass percentage of respective component in the total mass of all components; the R-T-B magnet comprises a Ti₂₆Cu₂₅B₄₉ phase in an intergranular triangular region thereof, and the ratio of the area of the Ti₂₆Cu₂₅B₄₉ phase to the total area of “the neodymium-rich phase and the intergranular triangular region” is 3.6%.

In a specific example of the invention, the R-T-B magnet comprises the following components of: 30.6 wt % of Nd, 1 wt % of Co, 0.21 wt % of Cu, 0.45 wt % of Ti, 1 wt % of B, 0.02 wt % of Ga, 0.06 wt % of Al and 66.66 wt % of Fe, wherein wt % is the mass percentage of respective component in the total mass of all components; the R-T-B magnet comprises a Ti₂₄Cu₂₅B₅₁ phase in an intergranular triangular region thereof, and the ratio of the area of the Ti₂₄Cu₂₅B₅₁ phase to the total area of “the neodymium-rich phase and the intergranular triangular region” is 3.2%.

In a specific example of the invention, the R-T-B magnet comprises the following components of: 29.6 wt % of Nd, 1 wt % of Tb, 0.21 wt % of Cu, 0.45 wt % of Ti, 1 wt % of B, 0.19 wt % of Ga, 0.05 wt % of Al and 67.5 wt % of Fe, wherein wt % is the mass percentage of respective component in the total mass of all components; the R-T-B magnet comprises a Ti₂₃Cu₂₅B₅₂ phase in an intergranular triangular region thereof, and the ratio of the area of the Ti₂₃Cu₂₅B₅₂ phase to the total area of “the neodymium-rich phase and the intergranular triangular region” is 2.9%.

In a specific example of the invention, the R-T-B magnet comprises the following components of: 29.6 wt % of Nd, 1 wt % of Tb, 0.21 wt % of Cu, 0.55 wt % of Ti, 1 wt % of B, 0.02 wt % of Ga, 0.05 wt % of Al and 67.57 wt % of Fe, wherein wt % is the mass percentage of respective component in the total mass of all components; the R-T-B magnet comprises a Ti₂₇Cu₂₅B₄₈ phase in an intergranular triangular region thereof, and the ratio of the area of the Ti₂₇Cu₂₅B₄₈ phase to the total area of “the neodymium-rich phase and the intergranular triangular region” is 3.5%.
the R-T-B magnet comprises the following components of: 29.6 wt % of Nd, 1 wt % of Tb, 0.21 wt % of Cu, 0.7 wt % of Ti, 1 wt % of B, 0.02 wt % of Ga, 0.04 wt % of Al, and 67.43 wt % of Fe, wherein wt % is the mass percentage of respective component in the total mass of all components; the R-T-B magnet comprises a Ti₂₅Cu₂₅B₅₀ phase in an intergranular triangular region thereof, and the ratio of the area of the Ti₂₅Cu₂₅B₅₀ phase to the total area of “the neodymium-rich phase and the intergranular triangular region” is 3.4%.

In a specific example of the invention, the R-T-B magnet comprises the following components of: 29.6 wt % of Nd, 1 wt % of Tb, 0.34 wt % of Cu, 0.45 wt % of Ti, 1 wt % of B, 0.02 wt % of Ga, 0.05 wt % of Al and 67.54 wt % of Fe, wherein wt % is the mass percentage of respective component in the total mass of all components; the R-T-B magnet comprises a Ti₂₄Cu₂₄B₅₂ phase in an intergranular triangular region thereof, and the ratio of the area of the Ti₂₄Cu₂₄B₅₂ phase to the total area of “the neodymium-rich phase and the intergranular triangular region” is 3.7%.

In a specific example of the invention, the R-T-B magnet comprises the following components of: 29.6 wt % of Nd, 1 wt % of Tb, 0.21 wt % of Cu, 0.45 wt % of Ti, 1.04 wt % of B, 0.02 wt % of Ga, 0.04 wt % of Al and 67.64 wt % of Fe, wherein wt % is the mass percentage of respective component in the total mass of all components; the R-T-B magnet comprises a Ti₂₁Cu₂₁B₅₈ phase in an intergranular triangular region thereof, and the ratio of the area of the Ti₂₁Cu₂₁B₅₈ phase to the total area of “the neodymium-rich phase and the intergranular triangular region” is 3.6%.

In a specific example of the invention, the R-T-B magnet comprises the following components of: 31 wt % of Nd, 1 wt % of Tb, 0.21 wt % of Cu, 0.45 wt % of Ti, 0.96 wt % of B, 0.02 wt % of Ga, 0.06 wt % of Al and 66.3 wt % of Fe, wherein wt % is the mass percentage of respective component in the total mass of all components; the R-T-B magnet comprises a Ti₂₅Cu₂₃B₅₂ phase in an intergranular triangular region thereof, and the ratio of the area of the Ti₂₅Cu₂₃B₅₂ phase to the total area of “the neodymium-rich phase and the intergranular triangular region” is 3.9%.

In a specific example of the invention, the R-T-B magnet comprises the following components of: 29.8 wt % of Nd, 0.8 wt % of Tb, 0.21 wt % of Cu, 0.45 wt % of Ti, 1 wt % of B, 0.02 wt % of Ga, 0.14 wt % of Al, and 67.58 wt % of Fe, wherein wt % is the mass percentage of respective component in the total mass of all components; the R-T-B magnet comprises a Ti₂₄Cu₂₆B₅₀ phase in an intergranular triangular region thereof, and the ratio of the area of the Ti₂₄Cu₂₆B₅₀ phase to the total area of “the neodymium-rich phase and the intergranular triangular region” is 3.4%.

In a specific example of the invention, the R-T-B magnet comprises the following components of: 29.6 wt % of Nd, 1 wt % of Tb, 0.45 wt % of Cu, 0.6 wt % of Ti, 1.15 wt % of B, 0.06 wt % of Ga, 0.05 wt % of Al and 67.09 wt % of Fe, wherein wt % is the mass percentage of respective component in the total mass of all components; the R-T-B magnet comprises a Ti₂₇Cu₂₃B₅₀ phase in an intergranular triangular region thereof, and the ratio of the area of the Ti₂₇Cu₂₃B₅₀ phase to the total area of “the neodymium-rich phase and the intergranular triangular region” is 3.5%.

In a specific example of the invention, the R-T-B magnet comprises the following components of: 29.6 wt % of Nd, 1 wt % of Tb, 0.16 wt % of Cu, 0.4 wt % of Ti, 0.96 wt % of B, 0.01 wt % of Ga, 0.07 wt % of Al and 67.8 wt % of Fe, wherein wt % is the mass percentage of respective component in the total mass of all components; the R-T-B magnet comprises a Ti₂₄Cu₂₅B₅₁ phase in an intergranular triangular region thereof, and the ratio of the area of the Ti₂₄Cu₂₅B₅₁ phase to the total area of “the neodymium-rich phase and the intergranular triangular region” is 3.4%.

In a specific example of the invention, the R-T-B magnet comprises the following components of: 29.6 wt % of Nd, 1 wt % of Tb, 0.21 wt % of Cu, 0.4 wt % of Ti, 1 wt % of B, 0.04 wt % of Al and 67.75 wt % of Fe, wherein wt % is the mass percentage of respective component in the total mass of all components; the R-T-B magnet comprises a Ti₂₆Cu₂₆B₄₈ phase in an intergranular triangular region thereof, and the ratio of the area of the Ti₂₆Cu₂₆B₄₈ phase to the total area of “the neodymium-rich phase and the intergranular triangular region” is 3.5%.

In a specific example of the invention, the R-T-B magnet comprises the following components of: 30.1 wt % of Nd, 0.5 wt % of Dy, 0.21 wt % of Cu, 0.45 wt % of Ti, 1 wt % of B, 0.02 wt % of Ga, 0.05 wt % of Al, and 67.67 wt % of Fe, wherein wt % is the mass percentage of respective component in the total mass of all components; the R-T-B magnet comprises a Ti₂₅Cu₂₇B₄₈ phase in an intergranular triangular region thereof, and the ratio of the area of the Ti₂₅Cu₂₇B₄₈ phase to the total area of “the neodymium-rich phase and the intergranular triangular region” is 3.4%.

In a specific example of the invention, the R-T-B magnet comprises the following components of: 28.6 wt % of Nd, 2 wt % of Dy, 0.21 wt % of Cu, 0.5 wt % of Ti, 1 wt % of B, 0.02 wt % of Ga, 0.03 wt % of Al, and 67.64 wt % of Fe, wherein wt % is the mass percentage of respective component in the total mass of all components; the R-T-B magnet comprises a Ti₂₇Cu₂₈B₄₅ phase in an intergranular triangular region thereof, and the ratio of the area of the Ti₂₇Cu₂₈B₄₅ phase to the total area of “the neodymium-rich phase and the intergranular triangular region” is 3.5%.

In a specific example of the invention, the R-T-B magnet comprises the following components of: 29.6 wt % of Nd, 0.5 wt % of Tb, 0.5 wt % of Dy, 0.21 wt % of Cu, 0.48 wt % of Ti, 1 wt % of B, 0.02 wt % of Ga, 0.06 wt % of Al, 67.63 wt % of Fe, wherein wt % is the mass percentage of respective component in the total mass of all components; the R-T-B magnet comprises a Ti₂₄Cu₂₄B₅₂ phase in an intergranular triangular region thereof, and the ratio of the area of the Ti₂₄Cu₂₄B₅₂ phase to the total area of “the neodymium-rich phase and the intergranular triangular region” is 3.5%.

The invention further provides a preparation method of a R-T-B magnet, comprising the steps of subjecting a raw mixture comprising respective components for the R-T-B magnet to sintering treatment and aging treatment.

In the present invention, the temperature for the sintering treatment may be a conventional temperature in the field, preferably 1000-1100° C., and for example 1080° C.

In the present invention, the sintering treatment is preferably performed under a vacuum condition, such as a 5×10⁻³ Pa vacuum condition.

In the present invention, the time for the sintering treatment can be conventional in the field, generally 4-8 hours, such as 6 hours.

In the present invention, the aging treatment can adopt the conventional aging process in the field, which generally includes a primary aging treatment and a secondary aging treatment.

Wherein, the temperature for the primary aging treatment can be conventional in the field, preferably 860-920° C., such as 880° C. or 900° C.

Wherein, the time for the primary aging treatment can be conventional in the field, preferably 2.5-4 h, for example 3h.

Wherein, the temperature for the secondary aging treatment can be conventional in the field, preferably 460-530° C., such as 500° C., 510° C. or 520° C.

Wherein, the time for the secondary aging treatment may be 2.5-4 hours, such as 3 hours.

In the invention, when the R-T-B magnet further comprises a heavy rare earth element, the preparation method generally further comprises grain boundary diffusion after the aging treatment.

Wherein, the grain boundary diffusion can be a conventional process in the field, and generally the heavy rare earth elements are diffused at the grain boundary.

The temperature for the grain boundary diffusion may be 800-900° C., such as 850° C. The time for the grain boundary diffusion may be 5-10 hours, such as 8 hours.

Wherein, the addition method of heavy rare earth elements in the R-T-B magnet can be the conventional methods in the art. Generally, the method of adding heavy rare earth elements in the R-T-B magnet comprises the steps of adding 0-80% of heavy rare earth elements during the smelting and adding the remaining heavy rare earth elements during grain boundary diffusion, such as 25%, 30%, 40%, 50% or 67%. The heavy rare earth element added during smelting is, for example, Tb.

For example, when the heavy rare earth elements in the R-T-B magnet are Tb with a content of greater than 0.5 wt %, 40-67% of Tb is added during the smelting, and the rest is added during the grain boundary diffusion. For example, when the heavy rare earth elements in the R-T-B magnet are Tb and Dy, the Tb is added during smelting, and the Dy is added during the grain boundary diffusion. For example, when the heavy rare earth elements in the R-T-B magnet are Tb with a content of less than or equal to 0.5 wt %, or when the heavy rare earth elements in the R-T-B magnet are Dy, the heavy rare earth elements in the R-T-B magnet are added during the grain boundary diffusion.

Wherein, the preparation method generally further comprises a further secondary aging treatment after the grain boundary diffusion. The temperature and time range of the further secondary aging treatment are as described above. The temperature is, for example, 500° C. The time is, for example, 3 h.

In the invention, those skilled in the field know that, the preparation method further comprises the conventional processes of smelting, casting, hydrogen decrepitation, pulverization and magnetic field shaping before the sintering treatment.

Wherein, the vacuum degree for the smelting is, for example, 5×10⁻² Pa.

Wherein the temperature for the smelting is preferably 1550° C. or less.

Wherein, the smelting is generally carried out in a high-frequency vacuum induction smelting furnace.

Wherein, the casting process, for example, can be a strip casting process.

Wherein, the temperature for the casting may be 1390-1460° C., such as 1400, 1420° C. or 1430° C.

Wherein, the alloy casting sheet obtained after the casting may have a thickness of 0.25-0.40 mm, for example, 0.29 mm.
wherein, the process of hydrogen decrepitation generally comprises hydrogen absorption, dehydrogenation, and cooling treatment in turn.

The hydrogen absorption can be carried out under the condition of hydrogen pressure of 0.085 MPa.

The dehydrogenation can be carried out under the condition of raising the temperature while evacuating. The dehydrogenation temperature may be 480-520° C., such as 500° C.

Wherein, the pulverization may be jet mill pulverization.

Wherein, the particle size of the powder obtained after the pulverization can be 4.1-4.4 μm, such as 4.1 μm, 4.2 μm or 4.3 μm.

Wherein, the gas atmosphere during the pulverization can be a gas atmosphere with an oxidizing gas content of 1000 ppm or less. The oxidizing gas content refers to the content of oxygen or moisture.

Wherein, the pressure during the pulverization is, for example, 0.68 MPa.

Wherein, after the pulverization, a lubricant such as zinc stearate is generally added.

Wherein, the added amount of the lubricant may be 0.05-0.15%, such as 0.12%, of the mass of the powder obtained after the pulverization.

Wherein, the magnetic field shaping is carried out under the protection of a nitrogen atmosphere with a magnetic field strength of 1.8T or more. For example, it is carried out under the magnetic field strength of 1.8-2.5T.

The invention further provides a R-T-B magnet prepared by the above preparation method.

On the basis of conforming to common knowledge in the field, the above-mentioned preferred conditions can be combined arbitrarily to obtain the preferred examples of the present invention.

The reagents and raw materials used in the present invention are all commercially available.

The positive progress effects of the present invention are as follows:

As far as the R-T-B magnet of the present invention, the coordination relationship between respective elements is optimized by the coordination among the elements such as Cu, Ti, Ga, and the like having specific contents, so that its microstructure is optimized in the process of preparing the R-T-B magnet, which obtained magnet materials whose magnetic properties such as coercivity, high-temperature stability and squareness are all at a high level.

### BRIEF DESCRIPTION OF THE DRAWINGS

FIG. 1 shows the SEM spectrum of the R-T-B magnet with Ti₂₃Cu₂₅B₅₂ phases in Example 1. The arrows a in FIG. 1 point to the Ti₂₃Cu₂₅B₅₂ phases in the intergranular triangular regions.

### DETAILED DESCRIPTION OF THE INVENTION

The present invention is further illustrated below by means of examples, but the present invention is not limited to the scope of the examples. The experimental methods not indicating specific conditions in the following examples were carried out according to conventional methods and conditions, or were selected according to the product instructions.

### Example 1

Raw materials were prepared according to the compositions of the R-T-B magnets shown in Table 1, and R-T-B magnets were prepared by the following steps:

(1) Smelting Process:

The prepared raw materials (with respect to Tb shown in Table 1, 0.4 wt % thereof was added in smelting and the remaining 0.6 wt % was added in the grain boundary diffusion described below) were put into a high-frequency vacuum induction melting furnace with a vacuum degree of 5×10² Pa, and smelted at a temperature of 1550° C. or less to obtain a molten liquid.

(2) Casting Process:

An alloy casting sheet with a thickness of 0.29 mm was obtained by a quick-setting strip casting method, wherein the casting temperature was 1420° C.

(3) Hydrogen Decrepitation Process:

The material was subjected to hydrogen absorption, dehydrogenation and cooling treatments. The hydrogen absorption was carried out under the condition of hydrogen pressure of 0.085 MPa. The dehydrogenation was carried out under the condition of raising the temperature while evacuating, wherein the dehydrogenation temperature was 500° C.

(4) Pulverization Process:

Jet milling was carried out in an atmosphere with an oxidizing gas content of 100 ppm or less to obtain a powder with a particle size of 4.2 μm. The oxidizing gas was oxygen or moisture content. The pressure in the grinding chamber of the jet mill was 0.68 MPa. After pulverizing, a lubricant, that is, zinc stearate, was added, and the addition amount thereof was 0.12% by weight of the powder after mixing.

(6) Magnetic Field Shaping Process:

By magnetic field shaping method, the shaping was carried out at a magnetic field strength of 1.8-2.5 T under the protection of a nitrogen atmosphere.

(7) Sintering Process:

Sintering and cooling were carried out under the vacuum condition of 5×10⁻³ Pa. The sintering was performed at 1080° C. for 6 h. Before cooling, Ar gas can be introduced to make the pressure reach 0.05 MPa.

(8) Aging Treatment:

A primary aging was carried out at a temperature of 900° C. for 3 h; and a secondary aging was carried out at a temperature of 510° C. for 3 h.

(9) Grain Boundary Diffusion Treatment:

The remaining 0.6 wt % of Tb was diffused into the magnet material by the grain boundary diffusion treatment. The grain boundary diffusion was carried out at a temperature of 850° C. for 8 h.

After the grain boundary diffusion was completed, a further secondary aging was performed at a temperature of 500° C. for 3 hours.

Regarding Examples 2-21 and Comparative Examples 1-5, the raw materials thereof were prepared according to the formula in Table 1 below, and the corresponding R-T-B magnets were prepared according to the preparation process of Example 1.

Specifically, in Examples 2, 3, 7, 9-18 and Comparative Examples 1-4, 0.4 wt % of Tb was added during smelting, and the remaining Tb was diffused into the R-T-B magnets during the grain boundary diffusion; in Examples 4, 5, 19 and 20, the heavy rare earth elements were all added during the grain boundary diffusion; and in Example 21, Tb was added during smelting, and Dy was added during the grain boundary diffusion.

### Effect Example 1

1. Determination of Ingredients:

The R-T-B magnets prepared in Examples 1-21 and Comparative Examples 1-5 were measured using a high frequency inductively coupled plasma optical emission spectrometer (JCP-OES). The testing results are shown in Table 1 below.

TABLE 1
Formulas (wt %) of the R-T-B magnets in Examples
1-21 and Comparative Examples 1-4

| | Nd | Tb | Dy | Co | Cu | Ti | B | Ga | Al | Fe |
|---|---|---|---|---|---|---|---|---|---|---|
| Example 1 | 29.6 | 1 | / | / | 0.21 | 0.45 | 1 | 0.02 | 0.04 | 67.68 |
| Example 2 | 29.8 | 0.8 | / | / | 0.21 | 0.45 | 1 | 0.02 | 0.05 | 67.67 |
| Example 3 | 30 | 0.6 | / | / | 0.21 | 0.45 | 1 | 0.02 | 0.04 | 67.68 |
| Example 4 | 30.2 | 0.4 | / | / | 0.21 | 0.45 | 1 | 0.02 | 0.08 | 67.64 |
| Example 5 | 30.4 | 0.2 | / | / | 0.21 | 0.45 | 1 | 0.02 | 0.02 | 67.7 |
| Example 6 | 30.6 | 0 | / | / | 0.21 | 0.45 | 1 | 0.02 | 0.05 | 67.67 |
| Example 7 | 29.6 | 1 | / | 1 | 0.21 | 0.45 | 1 | 0.02 | 0.04 | 66.68 |
| Example 8 | 30.6 | 0 | / | 1 | 0.21 | 0.45 | 1 | 0.02 | 0.06 | 66.66 |
| Example 9 | 29.6 | 1 | / | / | 0.21 | 0.45 | 1 | 0.19 | 0.05 | 67.5 |
| Example 10 | 29.6 | 1 | / | / | 0.21 | 0.55 | 1 | 0.02 | 0.05 | 67.57 |
| Example 11 | 29.6 | 1 | / | / | 0.21 | 0.7 | 1 | 0.02 | 0.04 | 67.43 |
| Example 12 | 29.6 | 1 | / | / | 0.34 | 0.45 | 1 | 0.02 | 0.05 | 67.54 |
| Example 13 | 29.6 | 1 | / | / | 0.21 | 0.45 | 1.04 | 0.02 | 0.04 | 67.64 |
| Example 14 | 31 | 1 | / | / | 0.21 | 0.45 | 0.96 | 0.02 | 0.06 | 66.3 |
| Example 15 | 29.8 | 0.8 | / | / | 0.21 | 0.45 | 1 | 0.02 | 0.14 | 67.58 |
| Example 16 | 29.6 | 1 | / | / | 0.45 | 0.6 | 1.15 | 0.06 | 0.05 | 67.09 |
| Example 17 | 29.6 | 1 | / | / | 0.16 | 0.4 | 0.96 | 0.01 | 0.07 | 67.8 |
| Example 18 | 29.6 | 1 | / | / | 0.21 | 0.4 | 1 | 0 | 0.04 | 67.75 |
| Example 19 | 30.1 | / | 0.5 | / | 0.21 | 0.45 | 1 | 0.02 | 0.05 | 67.67 |
| Example 20 | 28.6 | / | 2 | / | 0.21 | 0.5 | 1 | 0.02 | 0.03 | 67.64 |
| Example 21 | 29.6 | 0.5 | 0.5 | / | 0.21 | 0.48 | 1 | 0.02 | 0.06 | 67.63 |
| Comparative | 29.6 | 1 | / | / | 0.15 | 0.45 | 1 | 0.02 | 0.06 | 67.72 |
| Example 1 | | | | | | | | | | |
| Comparative | 29.6 | 1 | / | / | 0.21 | 0.38 | 1 | 0.02 | 0.05 | 67.74 |
| Example 2 | | | | | | | | | | |
| Comparative | 29.6 | 1 | / | / | 0.21 | 0.45 | 0.95 | 0.02 | 0.03 | 67.74 |
| Example 3 | | | | | | | | | | |
| Comparative | 29.6 | 1 | / | / | 0.21 | 0.45 | 1 | 0.22 | 0.05 | 67.47 |
| Example 4 | | | | | | | | | | |
| Comparative | 30.6 | / | / | / | 0.15 | 0.45 | 1 | 0.02 | 0.06 | 67.72 |
| Example 5 | | | | | | | | | | |

Notes:
/ indicates that this element is not included. The elements C, O and Mn are inevitably introduced into the final product R-T-B magnets during the preparation process, and these impurities are not included in the denominator of the content percentage calculated in each example and comparative example. In addition, Example 15 in Table 1 comprised 0.14 wt % of Al. According to common knowledge, a part of this Al content was attributed to impurities introduced during the preparation process. The contents of Al being 0.08 wt % or less in the remaining examples and comparative examples were introduced during the preparation process.

2. Testing for Magnetic Performance

The R-T-B magnets in Examples 1-21 and Comparative Examples 1-5 were tested by using a PFM pulsed BHT demagnetization curve testing equipment to obtain the data of remanence (Br), intrinsic coercivity (Hcj), maximum energy product (BHmax) and squareness (Hk/Hcj). The testing results are shown in Table 2 below.

TABLE 2

| | | | | | | | 20-150° C. Hcj |
|---|---|---|---|---|---|---|---|
| | 20° C. | 20° C. | | 20° C. | 150° C. | | Temperature |
| | Br | Hcj | 20° C. | BHmax | Hcj | 150° C. | Coefficient |
| No. | (kGs) | (kOe) | Hk/Hcj | (MGOe) | (kOe) | Hk/Hcj | (%) |
| Example 1 | 14.34 | 26.10 | 0.99 | 48.96 | 12.01 | 0.99. | −0.42 |
| Example 2 | 14.39 | 25.10 | 0.99 | 49.30 | 11.50 | 0.99 | −0.42 |
| Example 3 | 14.43 | 25.20 | 0.99 | 49.58 | 11.53 | 0.98 | −0.42 |
| Example 4 | 14.48 | 23.40 | 0.98 | 49.92 | 10.48 | 0.99 | −0.42 |
| Example 5 | 14.52 | 22.50 | 0.99 | 50.20 | 10.10 | 0.99 | −0.42 |
| Example 6 | 14.57 | 20.60 | 0.99 | 50.54 | 9.34 | 0.99 | −0.42 |
| Example 7 | 14.38 | 26.70 | 0.99 | 49.23 | 12.14 | 0.99 | −0.42 |
| Example 8 | 14.50 | 21.00 | 0.98 | 50.06 | 9.62 | 0.99 | −0.42 |
| Example 9 | 14.30 | 25.30 | 0.99 | 48.69 | 11.40 | 0.98 | −0.42 |
| Example 10 | 14.30 | 26.30 | 0.99 | 48.69 | 11.78 | 0.99 | −0.42 |
| Example 11 | 14.28 | 26.10 | 0.99 | 48.55 | 11.76 | 0.99 | −0.42 |
| Example 12 | 14.33 | 26.30 | 0.98 | 48.89 | 11.88 | 0.99 | −0.42 |
| Example 13 | 14.28 | 25.90 | 0.99 | 48.55 | 11.65 | 0.98 | −0.42 |
| Example 14 | 14.04 | 26.70 | 0.99 | 46.93 | 12.24 | 0.99 | −0.42 |
| Example 15 | 14.29 | 25.60 | 0.99 | 48.62 | 11.68 | 0.98 | −0.42 |
| Example 16 | 14.13 | 26.00 | 0.98 | 47.54 | 11.74 | 0.99 | −0.42 |
| Example 17 | 14.38 | 25.80 | 0.99 | 49.23 | 11.71 | 0.98 | −0.42 |
| Example 18 | 14.35 | 25.70 | 0.98 | 49.03 | 11.63 | 0.99 | −0.42 |
| Example 19 | 14.42 | 23.30 | 0.99 | 49.51 | 10.70 | 0.98 | −0.42 |
| Example 20 | 14.01 | 26.80 | 0.99 | 46.73 | 12.15 | 0.99 | −0.42 |
| Example 21 | 14.31 | 25.20 | 0.99 | 48.76 | 11.57 | 0.99 | −0.42 |
| Comparative | 14.32 | 23.30 | 0.96 | 48.82 | 9.31 | 0.95 | −0.46 |
| Example 1 | | | | | | | |
| Comparative | 14.34 | 24.20 | 0.93 | 48.96 | 9.67 | 0.92 | −0.46 |
| Example 2 | | | | | | | |
| Comparative | 14.42 | 23.90 | 0.92 | 49.51 | 9.50 | 0.90 | −0.46 |
| Example 3 | | | | | | | |
| Comparative | 14.40 | 24.10 | 0.94 | 49.37 | 9.67 | 0.93 | −0.46 |
| Example 4 | | | | | | | |
| Comparative | 14.32 | 18.32 | 0.95 | 48.82 | 7.36 | 0.94 | −0.46 |
| Example 5 | | | | | | | |

3. Testing for Microstructures

FE-EPMA Detection:

The vertically oriented faces of the R-T-B magnets in Examples 1-21 and Comparative Examples 1-5 were polished, and tested by using a Field Emission Electron Probe Microanalyzer (FE-EPMA) (JEOL, 8530F). Firstly, the distribution of Cu, Ti, B and other elements in the R-T-B magnets was determined by surface scanning using FE-EPMA. Then, the content of each element in the Ti—Cu—B phase was determined by single-point quantitative analysis using FE-EPMA. The test conditions included an accelerating voltage of 15 kv and a probe beam current of 50 nA.

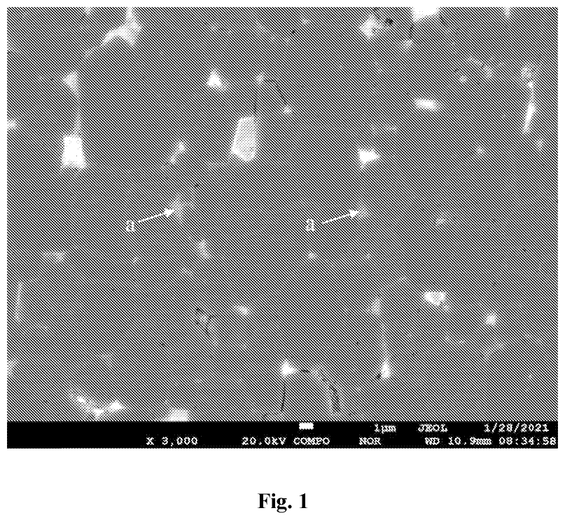

FIG. 1 shows the SEM image of the R-T-B magnet in Example 1 detected by FE-EPMA. The positions of the Ti—Cu—B phases were determined through the SEM image to be in the intergranular triangle area, and the area ratio of the Ti—Cu—B phases was further calculated. The arrows a in FIG. 1 indicate the Ti—Cu—B phases in the intergranular triangular region as determined by the single-point quantitative analysis.

It can be determined through detection and calculation that the Ti—Cu—B phases are formed in the intergranular triangular region of the R-T-B magnet in Example 1. In this Ti—Cu—B phase, the atomic percentage of Ti, Cu and B is 23:25:52, and thus the Ti—Cu—B phase is expressed as Ti₂₃Cu₂₅B₅₂ phase. The ratio of the area of the Ti₂₃Cu₂₅B₅₂ phase to the total area of “the intergranular triangular region and the Nd-rich phase” (which is referred to as Ratio of Phase Area in Table 3) is 3.5%. The area of the Ti₂₃Cu₂₅B₅₂ phase and the total area of “the intergranular triangular region and the Nd-rich phase” refer to the areas occupied in the section (the aforementioned vertically oriented face) of the testing R-T-B magnet respectively when detected by the FE-EPMA.

The testing results of the R-T-B magnets in Examples 1-21 and Comparative Examples 1-5 by the FE-EPMA are shown in Table 3 below.

TABLE 3

| | Phase structures | Ratio of Phase Area (%) |
|---|---|---|
| Example 1 | Ti₂₃Cu₂₅B₅₂ | 3.5 |
| Example 2 | Ti₂₃Cu₂₄B₅₃ | 3.4 |
| Example 3 | Ti₂₂Cu₂₆B₅₂ | 3.6 |
| Example 4 | Ti₂₅Cu₂₅B₅₀ | 3.5 |
| Example 5 | Ti₂₄Cu₂₆B₅₀ | 3.5 |
| Example 6 | Ti₂₂Cu₂₃B₅₅ | 3.2 |
| Example 7 | Ti₂₆Cu₂₅B₄₉ | 3.6 |
| Example 8 | Ti₂₄Cu₂₅B₅₁ | 3.2 |
| Example 9 | Ti₂₃Cu₂₅B₅₂ | 2.9 |
| Example 10 | Ti₂₇Cu₂₅B₄₈ | 3.5 |
| Example 11 | Ti₂₅Cu₂₅B₅₀ | 3.4 |
| Example 12 | Ti₂₄Cu₂₄B₅₂ | 3.7 |
| Example 13 | Ti₂₁Cu₂₁B₅₈ | 3.6 |
| Example 14 | Ti₂₅Cu₂₃B₅₂ | 3.9 |
| Example 15 | Ti₂₄Cu₂₆B₅₀ | 3.4 |
| Example 16 | Ti₂₇Cu₂₃B₅₀ | 3.5 |
| Example 17 | Ti₂₄Cu₂₅B₅₁ | 3.4 |
| Example 18 | Ti₂₆Cu₂₆B₄₈ | 3.5 |
| Example 19 | Ti₂₅Cu₂₇B₄₈ | 3.4 |
| Example 20 | Ti₂₇Cu₂₈B₄₅ | 3.5 |
| Example 21 | Ti₂₄Cu₂₄B₅₂ | 3.5 |
| Comparative Example 1 | Ti₂₄Cu₂₆B₅₀ | 0.8 |
| Comparative Example 2 | Ti₂₅Cu₂₅B₅₀ | 0.7 |
| Comparative Example 3 | Ti₂₄CU₂₃B₅₃ | 0.8 |
| Comparative Example 4 | Ti₂₃Cu₂₆B₅₁ | 0.9 |
| Comparative Example 5 | Ti₂₄Cu₂₆B₅₀ | 0.9 |

Although the specific implementation of the present invention has been described above, those skilled in the art should understand that this is only an example, and the protection scope of the present invention is defined by the appended claims. Those skilled in the art can make various changes or modifications to these embodiments without departing from the principle and essence of the present invention, and these changes and modifications all fall within the protection scope of the present invention.

1. A R-T-B magnet, comprising the following components of:
≥30.0 wt % of R, said R is a rare earth element;
0.16-0.6 wt % of Cu;
0.4-0.8 wt % of Ti;
≤0.2 wt % of Ga;
0.955-1.2 wt % of B; and
58-69% of Fe; wherein
wt % is the mass percentage of respective component in the total mass of all components.

2. The R-T-B magnet according to claim 1, wherein:
the content of R is 30.5 wt % or more and/or
the R further comprises Nd; and/or
the R further comprises Pr and/or RH, and the RH is a heavy rare earth element.

3. The R-T-B magnet according to claim 1, wherein:
the content of Cu is 0.16-0.45 wt %; and/or
the content of Ti is 0.4-0.7 wt %; and/or
the content of Ga is 0.01-0.19 wt %; and/or
the content of B is 0.96-1.15 wt %; and/or
the ratio of the atomic percentage of B to the atomic percentage of R in the R-T-B magnet is 0.35 or more; and/or
the content of Fe is 66-68 wt %.

4. The R-T-B magnet according to claim 1, wherein:
the R-T-B magnet further comprises Al; and/or
the R-T-B magnet further comprises Co.

5. The R-T-B magnet according to claim 1, wherein the R-T-B magnet further comprises a TiₓCu_{y}B_{1-x-y} phase, wherein x is 20-30, y is 20-30, and 1−x−y is 40-60, wherein x, y, and 1−x−y refer to the atomic percentages of Ti, Cu, and B respectively in the TiₓCu_{y}B_{1-x-y} phase; the TiₓCu_{y}B_{1-x-y} phase is located in an intergranular triangular region, and the ratio of the area of the TiₓCu_{y}B_{1-x-y} phase to the total area of “a neodymium-rich phase and the intergranular triangular region” is 1-5%.

6. The R-T-B magnet according to claim 1, wherein:
the R-T-B magnet comprises the following components of: 29.6 wt % of Nd, 1 wt % of Tb, 0.21 wt % of Cu, 0.45 wt % of Ti, 1 wt % of B, 0.02 wt % of Ga, 0.04 wt % of Al, and 67.68 wt % of Fe, wherein wt % is the mass percentage of respective component in the total mass of all components; the R-T-B magnet comprises a Ti₂₃Cu₂₅B₅₂ phase in an intergranular triangular region thereof, and the ratio of the area of the Ti₂₃Cu₂₅B₅₂ phase to the total area of “the neodymium-rich phase and the intergranular triangular region” is 3.5%; or
the R-T-B magnet comprises the following components of: 29.8 wt % of Nd, 0.8 wt % of Tb, 0.21 wt % of Cu, 0.45 wt % of Ti, 1 wt % of B, 0.02 wt % of Ga, 0.05 wt % of Al, and 67.67 wt % of Fe, wherein wt % is the mass percentage of respective component in the total mass of all components; the R-T-B magnet comprises a Ti₂₃Cu₂₄B₅₃ phase in an intergranular triangular region thereof, and the ratio of the area of the Ti₂₃Cu₂₄B₅₃ phase to the total area of “the neodymium-rich phase and the intergranular triangular region” is 3.4%; or
the R-T-B magnet comprises the following components of: 30 wt % of Nd, 0.6 wt % of Tb, 0.21 wt % of Cu, 0.45 wt % of Ti, 1 wt % of B, 0.02 wt % of Ga, 0.04 wt % of Al, and 67.68 wt % of Fe, wherein wt % is the mass percentage of respective component in the total mass of all components; the R-T-B magnet comprises a Ti₂₂Cu₂₆B₅₂ phase in an intergranular triangular region thereof, and the ratio of the area of the Ti₂₂Cu₂₆B₅₂ phase to the total area of “the neodymium-rich phase and the intergranular triangular region” is 3.6%; or
the R-T-B magnet comprises the following components of: 30.2 wt % of Nd, 0.4 wt % of Tb, 0.21 wt % of Cu, 0.45 wt % of Ti, 1 wt % of B, 0.02 wt % of Ga, 0.08 wt % of Al and 67.64 wt % of Fe, wherein wt % is the mass percentage of respective component in the total mass of all components; the R-T-B magnet comprises a Ti₂₅Cu₂₅B₅₀ phase in an intergranular triangular region thereof, and the ratio of the area of the Ti₂₅Cu₂₅B₅₀ phase to the total area of “the neodymium-rich phase and the intergranular triangular region” is 3.5%; or
the R-T-B magnet comprises the following components of: 30.4 wt % of Nd, 0.2 wt % of Tb, 0.21 wt % of Cu, 0.45 wt % of Ti, 1 wt % of B, 0.02 wt % of Ga, 0.02 wt % of Al and 67.7 wt % of Fe, wherein wt % is the mass percentage of respective component in the total mass of all components; the R-T-B magnet comprises a Ti₂₄Cu₂₆B₅₀ phase in an intergranular triangular region thereof, and the ratio of the area of the Ti₂₄Cu₂₆B₅₀ phase to the total area of “the neodymium-rich phase and the intergranular triangular region” is 3.5%; or
the R-T-B magnet comprises the following components of: 30.6 wt % of Nd, 0.21 wt % of Cu, 0.45 wt % of Ti, 1 wt % of B, 0.02 wt % of Ga, 0.05 wt % of Al and 67.67 wt % of Fe, wherein wt % is the mass percentage of respective component in the total mass of all components; the R-T-B magnet comprises a Ti₂₂Cu₂₃B₅₅ phase in an intergranular triangular region thereof, and the ratio of the area of the Ti₂₂Cu₂₃B₅₅ phase to the total area of “the neodymium-rich phase and the intergranular triangular region” is 3.2%; or
the R-T-B magnet comprises the following components of: 29.6 wt % of Nd, 1 wt % of Tb, 1 wt % of Co, 0.21 wt % of Cu, 0.45 wt % of Ti, 1 wt % of B, 0.02 wt % of Ga, 0.04 wt % of Al and 66.68 wt % of Fe, wherein wt % is the mass percentage of respective component in the total mass of all components; the R-T-B magnet comprises a Ti₂₆Cu₂₅B₄₉ phase in an intergranular triangular region thereof, and the ratio of the area of the Ti₂₆Cu₂₅B₄₉ phase to the total area of “the neodymium-rich phase and the intergranular triangular region” is 3.6%; or
the R-T-B magnet comprises the following components of: 30.6 wt % of Nd, 1 wt % of Co, 0.21 wt % of Cu, 0.45 wt % of Ti, 1 wt % of B, 0.02 wt % of Ga, 0.06 wt % of Al and 66.66 wt % of Fe, wherein wt % is the mass percentage of respective component in the total mass of all components; the R-T-B magnet comprises a Ti₂₄Cu₂₅B₅₁ phase in an intergranular triangular region thereof, and the ratio of the area of the Ti₂₄Cu₂₅B₅₁ phase to the total area of “the neodymium-rich phase and the intergranular triangular region” is 3.2%; or
the R-T-B magnet comprises the following components of: 29.6 wt % of Nd, 1 wt % of Tb, 0.21 wt % of Cu, 0.45 wt % of Ti, 1 wt % of B, 0.19 wt % of Ga, 0.05 wt % of Al and 67.5 wt % of Fe, wherein wt % is the mass percentage of respective component in the total mass of all components; the R-T-B magnet comprises a Ti₂₃Cu₂₅B₅₂ phase in an intergranular triangular region thereof, and the ratio of the area of the Ti₂₃Cu₂₅B₅₂ phase to the total area of “the neodymium-rich phase and the intergranular triangular region” is 2.9%; or
the R-T-B magnet comprises the following components of: 29.6 wt % of Nd, 1 wt % of Tb, 0.21 wt % of Cu, 0.55 wt % of Ti, 1 wt % of B, 0.02 wt % of Ga, 0.05 wt % of Al and 67.57 wt % of Fe, wherein wt % is the mass percentage of respective component in the total mass of all components; the R-T-B magnet comprises a Ti₂₇Cu₂₅B₄₈ phase in an intergranular triangular region thereof, and the ratio of the area of the Ti₂₇Cu₂₅B₄₈ phase to the total area of “the neodymium-rich phase and the intergranular triangular region” is 3.5%; or
the R-T-B magnet comprises the following components of: 29.6 wt % of Nd, 1 wt % of Tb, 0.21 wt % of Cu, 0.7 wt % of Ti, 1 wt % of B, 0.02 wt % of Ga, 0.04 wt % of Al, and 67.43 wt % of Fe, wherein wt % is the mass percentage of respective component in the total mass of all components; the R-T-B magnet comprises a Ti₂₅Cu₂₅B₅₀ phase in an intergranular triangular region thereof, and the ratio of the area of the Ti₂₅Cu₂₅B₅₀ phase to the total area of “the neodymium-rich phase and the intergranular triangular region” is 3.4%; or
the R-T-B magnet comprises the following components of: 29.6 wt % of Nd, 1 wt % of Tb, 0.34 wt % of Cu, 0.45 wt % of Ti, 1 wt % of B, 0.02 wt % of Ga, 0.05 wt % of Al and 67.54 wt % of Fe, wherein wt % is the mass percentage of respective component in the total mass of all components; the R-T-B magnet comprises a Ti₂₄Cu₂₄B₅₂ phase in an intergranular triangular region thereof, and the ratio of the area of the Ti₂₄Cu₂₄B₅₂ phase to the total area of “the neodymium-rich phase and the intergranular triangular region” is 3.7%; or
the R-T-B magnet comprises the following components of: 29.6 wt % of Nd, 1 wt % of Tb, 0.21 wt % of Cu, 0.45 wt % of Ti, 1.04 wt % of B, 0.02 wt % of Ga, 0.04 wt % of Al and 67.64 wt % of Fe, wherein wt % is the mass percentage of respective component in the total mass of all components; the R-T-B magnet comprises a Ti₂₁Cu₂₁B₅₈ phase in an intergranular triangular region thereof, and the ratio of the area of the Ti₂₁Cu₂₁B₅₈ phase to the total area of “the neodymium-rich phase and the intergranular triangular region” is 3.6%; or
the R-T-B magnet comprises the following components of: 31 wt % of Nd, 1 wt % of Tb, 0.21 wt % of Cu, 0.45 wt % of Ti, 0.96 wt % of B, 0.02 wt % of Ga, 0.06 wt % of Al and 66.3 wt % of Fe, wherein wt % is the mass percentage of respective component in the total mass of all components; the R-T-B magnet comprises a Ti₂₅Cu₂₃B₅₂ phase in an intergranular triangular region thereof, and the ratio of the area of the Ti₂₅Cu₂₃B₅₂ phase to the total area of “the neodymium-rich phase and the intergranular triangular region” is 3.9%; or
the R-T-B magnet comprises the following components of: 29.8 wt % of Nd, 0.8 wt % of Tb, 0.21 wt % of Cu, 0.45 wt % of Ti, 1 wt % of B, 0.02 wt % of Ga, 0.14 wt % of Al, and 67.58 wt % of Fe, wherein wt % is the mass percentage of respective component in the total mass of all components; the R-T-B magnet comprises a Ti₂₄Cu₂₆B₅₀ phase in an intergranular triangular region thereof, and the ratio of the area of the Ti₂₄Cu₂₆B₅₀ phase to the total area of “the neodymium-rich phase and the intergranular triangular region” is 3.4%; or
the R-T-B magnet comprises the following components of: 29.6 wt % of Nd, 1 wt % of Tb, 0.45 wt % of Cu, 0.6 wt % of Ti, 1.15 wt % of B, 0.06 wt % of Ga, 0.05 wt % of Al and 67.09 wt % of Fe, wherein wt % is the mass percentage of respective component in the total mass of all components; the R-T-B magnet comprises a Ti₂₇Cu₂₃B₅₀ phase in an intergranular triangular region thereof, and the ratio of the area of the Ti₂₇Cu₂₃B₅₀ phase to the total area of “the neodymium-rich phase and the intergranular triangular region” is 3.5%; or
the R-T-B magnet comprises the following components of: 29.6 wt % of Nd, 1 wt % of Tb, 0.16 wt % of Cu, 0.4 wt % of Ti, 0.96 wt % of B, 0.01 wt % of Ga, 0.07 wt % of Al and 67.8 wt % of Fe, wherein wt % is the mass percentage of respective component in the total mass of all components; the R-T-B magnet comprises a Ti₂₄Cu₂₅B₅₁ phase in an intergranular triangular region thereof, and the ratio of the area of the Ti₂₄Cu₂₅B₅₁ phase to the total area of “the neodymium-rich phase and the intergranular triangular region” is 3.4%; or
the R-T-B magnet comprises the following components of: 29.6 wt % of Nd, 1 wt % of Tb, 0.21 wt % of Cu, 0.4 wt % of Ti, 1 wt % of B, 0.04 wt % of Al and 67.75 wt % of Fe, wherein wt % is the mass percentage of respective component in the total mass of all components; the R-T-B magnet comprises a Ti₂₆Cu₂₆B₄₈ phase in an intergranular triangular region thereof, and the ratio of the area of the Ti₂₆Cu₂₆B₄₈ phase to the total area of “the neodymium-rich phase and the intergranular triangular region” is 3.5%; or
the R-T-B magnet comprises the following components of: 30.1 wt % of Nd, 0.5 wt % of Dy, 0.21 wt % of Cu, 0.45 wt % of Ti, 1 wt % of B, 0.02 wt % of Ga, 0.05 wt % of Al, and 67.67 wt % of Fe, wherein wt % is the mass percentage of respective component in the total mass of all components; the R-T-B magnet comprises a Ti₂₅Cu₂₇B₄₈ phase in an intergranular triangular region thereof, and the ratio of the area of the Ti₂₅Cu₂₇B₄₈ phase to the total area of “the neodymium-rich phase and the intergranular triangular region” is 3.4%; or
the R-T-B magnet comprises the following components of: 28.6 wt % of Nd, 2 wt % of Dy, 0.21 wt % of Cu, 0.5 wt % of Ti, 1 wt % of B, 0.02 wt % of Ga, 0.03 wt % of Al, and 67.64 wt % of Fe, wherein wt % is the mass percentage of respective component in the total mass of all components; the R-T-B magnet comprises a Ti₂₇Cu₂₈B₄₅ phase in an intergranular triangular region thereof, and the ratio of the area of the Ti₂₇Cu₂₈B₄₅ phase to the total area of “the neodymium-rich phase and the intergranular triangular region” is 3.5%; or
the R-T-B magnet comprises the following components of: 29.6 wt % of Nd, 0.5 wt % of Tb, 0.5 wt % of Dy, 0.21 wt % of Cu, 0.48 wt % of Ti, 1 wt % of B, 0.02 wt % of Ga, 0.06 wt % of Al, 67.63 wt % of Fe, wherein wt % is the mass percentage of respective component in the total mass of all components; the R-T-B magnet comprises a Ti₂₄Cu₂₄B₅₂ phase in an intergranular triangular region thereof, and the ratio of the area of the Ti₂₄Cu₂₄B₅₂ phase to the total area of “the neodymium-rich phase and the intergranular triangular region” is 3.5%.

7. A preparation method of a R-T-B magnet, comprising subjecting a raw mixture comprising respective components for the R-T-B magnet of claim 1 to sintering treatment and aging treatment.

8. The preparation method of the R-T-B magnet according to claim 7, that wherein:
the temperature for the sintering treatment is 1000-1100° C.; and/or
the time for the sintering treatment is 4-8 hr; and/or
the aging treatment includes a primary aging treatment and a secondary aging treatment; and/or
when the R-T-B magnet further comprises a heavy rare earth element, the preparation method further comprises grain boundary diffusion after the aging treatment.

9. The preparation method of the R-T-B magnet according to claim 7, wherein:
the preparation method further comprises the steps of smelting, casting, hydrogen decrepitation, pulverization and magnetic field shaping in turn before the sintering treatment.

10. A R-T-B magnet prepared by the preparation method of the R-T-B magnet according to claim 7.

11. The R-T-B magnet according to claim 2, wherein the R-T-B magnet further comprises a TiₓCu_{y}B_{1-x-y} phase, wherein x is 20-30, y is 20-30, and 1−x−y is 40-60, wherein x, y, and 1−x−y refer to the atomic percentages of Ti, Cu, and B respectively in the TiₓCu_{y}B_{1-x-y} phase; the TiₓCu_{y}B_{1-x-y} phase is located in an intergranular triangular region, and the ratio of the area of the TiₓCu_{y}B_{1-x-y} phase to the total area of “a neodymium-rich phase and the intergranular triangular region” is 1-5%.

12. The R-T-B magnet according to claim 3, wherein the R-T-B magnet further comprises a TiₓCu_{y}B_{1-x-y} phase, wherein x is 20-30, y is 20-30, and 1−x−y is 40-60, wherein x, y, and 1−x−y refer to the atomic percentages of Ti, Cu, and B respectively in the TiₓCu_{y}B_{1-x-y} phase; the TiₓCu_{y}B_{1-x-y} phase is located in an intergranular triangular region, and the ratio of the area of the TiₓCu_{y}B_{1-x-y} phase to the total area of “a neodymium-rich phase and the intergranular triangular region” is 1-5%.

13. The R-T-B magnet according to claim 4, wherein the R-T-B magnet further comprises a TiₓCu_{y}B_{1-x-y} phase, wherein x is 20-30, y is 20-30, and 1−x−y is 40-60, wherein x, y, and 1−x−y refer to the atomic percentages of Ti, Cu, and B respectively in the TiₓCu_{y}B_{1-x-y} phase; the TiₓCu_{y}B_{1-x-y} phase is located in an intergranular triangular region, and the ratio of the area of the TiₓCu_{y}B_{1-x-y} phase to the total area of “a neodymium-rich phase and the intergranular triangular region” is 1-5%.
